(19) United States
(12) Patent Application Publication
(10) Pub. No.: US 2015/0017619 A1
(43) Pub. Date: Jan. 15, 2015

(54) RECORDING AND COMMUNICATING BODY MOTION

(71) Applicant: Bradley Charles Ashmore, Mountain View, CA (US)

(72) Inventor: Bradley Charles Ashmore, Mountain View, CA (US)

(21) Appl. No.: 14/321,524

(22) Filed: Jul. 1, 2014

Related U.S. Application Data
(60) Provisional application No. 61/845,217, filed on Jul. 11, 2013.

(51) Int. Cl. G09B 19/00; G09B 5/00

(52) U.S. Cl. CPC G09B 19/003; G09B 5/00
USPC 434/247

(57) ABSTRACT

Recording and communicating human body motion may be provided. One or more wearable device may each include a set of sensors for characterizing motion, a set of vibrating elements placed at different locations, and a radio. Data may be received from the wearable devices and stored at a mobile device. Such data may characterize a set of motions performed over a period of recording time by a recording user wearing the registered wearable devices. When a request for playback of the recorded motions is received at the mobile device from a user wearing the registered wearable devices, it may be determined that the requesting user has different dimensions than the recording user. As such, the stored data may be adjusted based on the difference in dimensions. The requesting user may then perform the motions and be evaluated in real-time to identify a deviation between the adjusted and the real-time data. The deviation is further identified as being associated with one of the wearable devices, and a signal is sent to that wearable device commanding one or more vibrating elements to actuate. Sets of motions may also be communicated to a repository, where each set of motions may be catalogued, tagged, filtered, searched, and distributed to various social networks and users.

### CROSS-REFERENCE TO RELATED APPLICATIONS

The present invention claims the priority benefit of U.S. provisional application No. 61/845,217 filed Jul. 11, 2013, the disclosure of which is incorporated herein by reference.

### BACKGROUND

1. Field of the Invention

The present invention generally relates to physical motion. More specifically, the present invention relates to systems and methods for recording and communicating human body motion.

2. Description of the Related Art

Presently available methods for communicating human body motion involve a live instructor demonstrating a movement in-person to one or more individuals and giving live instructions as the individuals perform the movement themselves. Such movements may be performed in the context of dance, exercise, sports, physical therapy, or other physical discipline, etc.

Achieving the goals of such disciplines generally requires attention to the human form during the movement. For example, a dance step may involve specific and coordinated placement of various limbs relative to each other. Because every individual moves differently, the instructor must generally observe and evaluate each individual separately and make the appropriate corrections, as needed.

Moreover, making corrections may involve demonstrating the move again, explaining why the individual did not perform the move successfully, and/or instructing the individual how to perform the move correctly. While the demonstration may be captured by various audio-visual media, such media fail to consider or be responsive to the individual needs of the individual, who may not have the knowledge, experience, or distance to even discern when he or she is performing the move incorrectly. Further, muscle memory may cause a move that is performed incorrectly to result in bad form or habits that may be difficult to correct. As such, instruction for most physical disciplines generally takes place in live classes where instructors can correct any errors in real-time, which may be difficult for some individuals to schedule or afford.

There is, therefore, a need in the art for improved systems and methods for recording and communicating human body motion.

### SUMMARY OF THE CLAIMED INVENTION

Embodiments of the present invention provide methods and systems for recording and communicating human body motion. One or more wearable device may each include a set of sensors for characterizing motion, a set of vibrating elements placed at different locations, and a radio. Data may be received from the wearable devices and stored at a mobile device. Such data may characterize a set of motions performed over a period of recording time by a recording user wearing the registered wearable devices. When a request for playback of the recorded motions is received at the mobile device from a user wearing the registered wearable devices, it may be determined that the requesting user has different dimensions than the recording user. As such, the stored data may be adjusted based on the difference in dimensions. The requesting user may then perform the motions and be evaluated in real-time to identify a deviation between the adjusted and the real-time data. The deviation is further identified as being associated with one of the wearable devices, and a signal is sent to that wearable device commanding one or more vibrating elements to actuate.

Various embodiments may include methods for recording and communicating human body motion. Such methods for recording and communicating human body motion may include storing data in memory of a mobile device. Such data, as captured by one or more wearable devices, may characterize a set of motions performed over a period of recording time by a recording user wearing the wearable devices. Methods may further include receiving a request for playback of the set of motions from a playing user wearing the wearable devices having certain dimensions, determining that the playing user has different dimensions than the recording user, adjusting the stored data regarding the set of motions performed by the recording user based on the difference in dimensions between the recording user and the playing user, evaluating real-time data regarding a set of motions performed by the requesting user over a period of playing time corresponding to the period of recording time, identifying a deviation between the adjusted data and the real-time data associated with at least one of the wearable devices, and sending a signal over the wireless communication network to the wearable device associated with the identified deviation, wherein the signal commands one or more vibrating elements of the identified wearable device to actuate.

Some embodiments may further include systems for recording and communicating human body motion. Such systems may include one or more wearable devices and a mobile device comprising memory that stores data captured by one or more wearable devices and characterizing a set of motions performed over a period of recording time by a recording user wearing the wearable devices, a user interface that receives a request for playback of the set of motions from a playing user wearing the wearable devices having certain dimensions, a processor that executes instructions to determine that the playing user has different dimensions than the recording user, to adjust the stored data regarding the set of motions performed by the recording user based on the difference in dimensions between the recording user and the playing user, to evaluate real-time data regarding a set of motions performed by the requesting user over a period of playing time corresponding to the period of recording time, and to identify a deviation between the adjusted data and the real-time data associated with at least one of the wearable devices, and a communication interface that sends a signal over the wireless communication network to the wearable device associated with the identified deviation that commands one or more vibrating elements of the identified wearable device to actuate.

Embodiments of the present invention may further include non-transitory computer-readable storage media, having embodied thereon a program executable by a processor to perform methods for recording and communicating human body motion as described herein.

### BRIEF DESCRIPTION OF THE FIGURES

FIGS. 1A and 1B illustrate exemplary tactile feedback devices that may be used in a system for recording and communicating human body motion.

FIGS. 2A-C illustrates an exemplary use case in which a system for recording and communicating human body motion may be implemented.

FIGS. 3A-B illustrates another exemplary use case in which a system for recording and communicating human body motion may be implemented.

FIG. 4 is a screenshot of an exemplary menu on a mobile device that may be used in a system for recording and communicating human body motion.

FIGS. 5A-F are screenshots that appear on the mobile device of FIG. 4 during an exemplary recording of a body motion.

FIGS. 6A-D are screenshots that appear on the mobile device of FIG. 4 during an exemplary playback of a body motion.

FIG. 7 is a diagram of an exemplary network environment in which a system for recording and communicating human body motion may be implemented.

FIG. 8 is a flowchart illustrating an exemplary method for recording and communicating human body motion.

### DETAILED DESCRIPTION

Embodiments of the present invention provide methods and systems for recording and communicating human body motion. One or more wearable device may each include a set of sensors for characterizing motion, a set of vibrating elements placed at different locations, and a radio. When used in conjunction with a mobile device, data may be received from the wearable devices and stored at the mobile device. Alternatively, the wearable devices may coordinate amongst themselves and store data locally or at a remote storage device (e.g., online repository). Such data may characterize a set of motions performed over a period of recording time by a recording user wearing the registered wearable devices. When a request for playback of the recorded motions is received at the mobile device from a user wearing the registered wearable devices, it may be determined that the requesting user has different dimensions than the recording user. As such, the stored data may be adjusted based on the difference in dimensions. The requesting user may then perform the motions and be evaluated in real-time to identify a deviation between the adjusted and the real-time data. The deviation is further identified as being associated with one of the wearable devices, and a signal is sent to that wearable device commanding one or more vibrating elements to actuate.

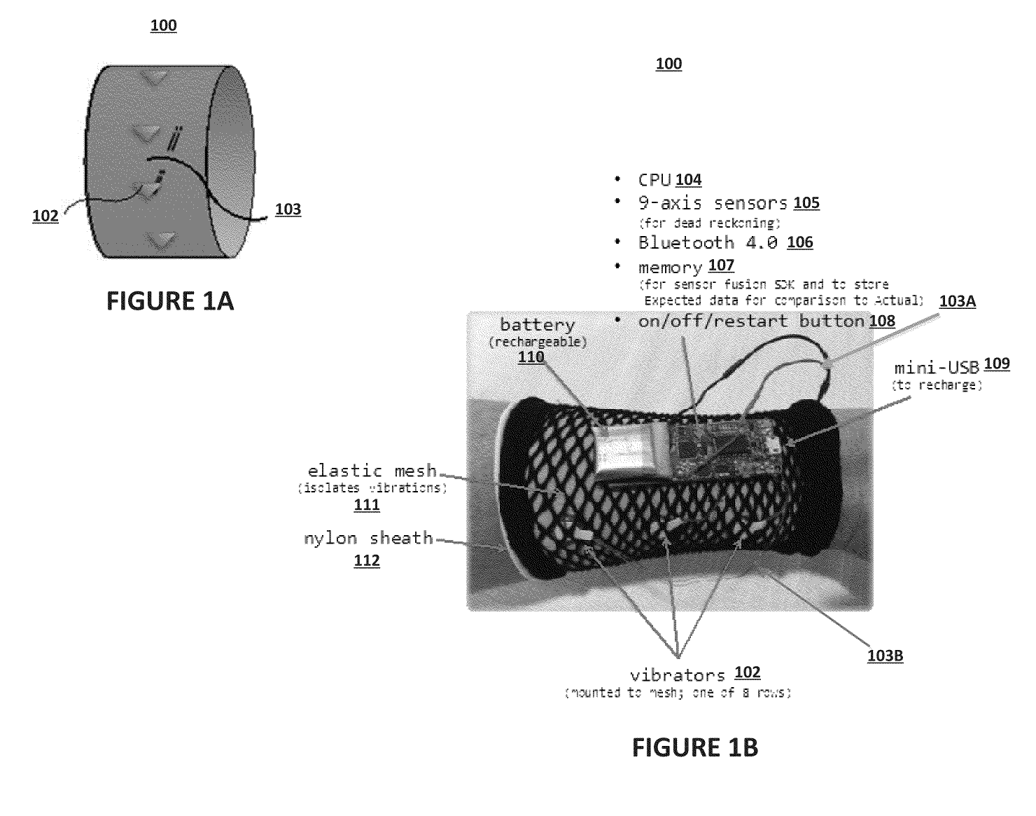

FIGS. 1A and 1B illustrate exemplary tactile feedback devices that may be used in a system for recording and communicating human body motion. Wearable device 100 is illustrated as a cuff, which may be made of any material, though preferably elastic to allow for a snug fit around a body part of the user (e.g., wrist, arm, ankle, leg).

Wearable device 100 is further illustrated as having a plurality of spaced vibrating elements 102. Such vibrating elements 102 may further be associated with various wires 103A-B. Such wires 103A-B may be used to connect to a power supply, to provide an electrical connection to the vibrating elements 102, as well as to provide structural support (e.g., prevent cuff from being stretched beyond length of electrical wire). An electrical signal may be sent via such wires 103B to one or more of the vibrating elements 102, resulting in actuation of the vibrating element(s) 102 to which the electrical signal was sent.

FIG. 1B provides an internal view of wearable device 100 (e.g., in which an external cover has been removed). Wearable device 100 may include not only vibrating elements 102 and wires 103, but also CPU 104, sensors 105, wireless interface 106 (e.g., Bluetooth), memory 107, ON/OFF/RESTART button 108, mini-USB 109, battery 110, elastic mesh 111, and nylon sheath 112.

In this regard, wires 103 may further serve to transmit data between the different components of wearable device 100. Such data may include positional data, rotational data, data regarding which vibrating element to actuate, and data signals with the actuation command.

CPU 104 may encompass any type of processor or controller known in the art for interpreting and manipulating data. In some embodiments, calculations regarding movement data may be performed at an associated application (e.g., on mobile device or at wearable device 100) and used to determine the type of response to transmit to the vibrating elements 102 of wearable device 100. In other embodiments, such calculations may be performed locally at the wearable device 100 by CPU 104.

Sensors 105 may encompass a plurality of different sensors for evaluating and characterizing position and movement. Such sensors 105 may include any combination of accelerometers, gyroscopes, magnetometers (e.g., compasses), and the like. In an exemplary embodiment, sensors 105 may comprise a three-axis accelerometer, a three-axis gyroscope, and a three-axis magnetometer. Such a configuration may be used in dead reckoning by which the accelerometer captures position data, the gyroscope captures rotational data, and the magnetometer reduces drift. Sensors 105 may further include a clock for capturing timing information, which may be important for time-based motions (e.g., dance). Such a clock may also be used in such functions as providing a countdown clock and automatic shut-off after a period of inactivity.

Wireless interface 106 may comprise any type of antenna for communicating wirelessly (e.g., with a mobile device). Such wireless interface 106 may communicate over WiFi, 4G/3G, Bluetooth, and/or any other known radio frequency communication network known in the art.

Memory 107 may include any type of memory or storage device known in the art. Such memory 107 may be used to provide temporary or long-term storage. In an exemplary embodiment, memory 107 may hold data regarding a set of motions (e.g., a physical therapy exercise) to be compared against real-time data regarding motions of a user wearing the wearable device 100. In addition, memory 107 may be used to store the real-time data for historical tracking and/or reporting purposes. Such data may subsequently be sent to an associated mobile device or repository for longer term storage and analyses.

ON/OFF/RESTART button 108 may be any type of mechanical, digital, or other type of button used to signal that the wearable device 100 is to be turned on, off, or restarted (e.g., reset to an original or default state). Mini-USB 109 may be used to recharge battery 110, which provides power to any of the other components of wearable device 100 that may require electrical power to operate.

Elastic mesh 111 is an exemplary foundation for attach the vibrating elements 102 to the rest of the wearable device 100. Such elastic mesh 111 serves to provide isolation between the vibrating elements 102, so as to allow a user wearing wearable device 100 to distinguish which vibrating element 102 is vibrating. While illustrated and characterized as elastic mesh 111 herein, elastic mesh 111 may encompass any type of material that can isolate the vibrations of multiple vibrating elements from each other.

A nylon sheath 112 may provide a smooth surface between the skin of the user and the other components of wearable device 100. Nylon sheath 112 should be thin enough, however, that the user can feel and distinguish the individual vibrations of any of the vibrating elements 102.

The wearable device 100 of FIGS. 1A-B may be used in conjunction with any number of other wearable devices 100 each worn on a different body part of the user to evaluate the movement of that body part. In addition, the wearable device(s) 100 may be associated with an application. Such an application registers the wearable device(s), as well as manages the recording of motions and directed playback of recorded motions (with tactile guidance).The application may also communicate with online repositories, maintain the user's catalog of saved motions, and has the user's physical dimensions to scale for accurate playback. The application can be on a mobile device (smartphone) and/or embedded in the wearable device. In that regard, the wearable device may be considered a specific type of mobile device.

Users may use any number of different electronic mobile devices, such as mobile phones, smartphones, personal digital assistants (PDAs), portable computing devices (e.g., tablets), handheld computing device, or any other type of computing device capable of communicating over a wireless communication network. Mobile devices may also be configured to access data from other storage media, such as memory cards or disk drives as may be appropriate in the case of downloaded services. Mobile device may include standard hardware computing components such as network and media interfaces, non-transitory computer-readable storage (memory), and processors for executing instructions that may be stored in memory.

Exemplary algorithms for executing the application may provide as follows:

| | |
|---|---|
| 1. | [user] Start the app via the (iOS) interface. |
| 2. | [app] All controls are disabled |
| 3. | [app] Scan for cuff(s). |
| | • The app will not know in advance how many cuffs to expect to pair with. |
| | • When the app is done scanning (X seconds pass without finding another |
| | cuff), it will display a popup with a message, e.g., ”2 cuffs found.” It is |
| | dismissed with ”OK”. |
| 4. | [app] The app displays the stored exercises as follows: |
| | If (no exercises had been stored) then |
| | If (at least one cuff was paired) then |
| | A popup displays, ”No exercises have been saved yet. Press + to |
| | record a new exercise.” |
| | Else |
| | A popup displays, ”No exercises have been saved yet. No cuffs were |
| | found. MoveItAgain needs at least one cuff if you wish to record an |
| | exercise. Try again by turning off the iPhone app, turn the cuff(s) off |
| | and on, and then start the app.” |
| | Endif |
| | Else (at least one exercise had been stored) |
| | The exercises are displayed in the scrollable list. If there are more than 5 |
| | exercises, then only 5 are displayed and the others are listed by scrolling. |
| | If (at least one cuff was paired) then |
| | A popup displays, ”Press + to record a new exercise.” |
| | Else |
| | A popup displays, ”No cuffs were found. MoveItAgain needs at least |
| | one cuff if you wish to record an exercise. Try again by turning off the |
| | iPhone app, turn the cuff(s) off and on, and then start the app.” |
| | Endif |
| | Endif |

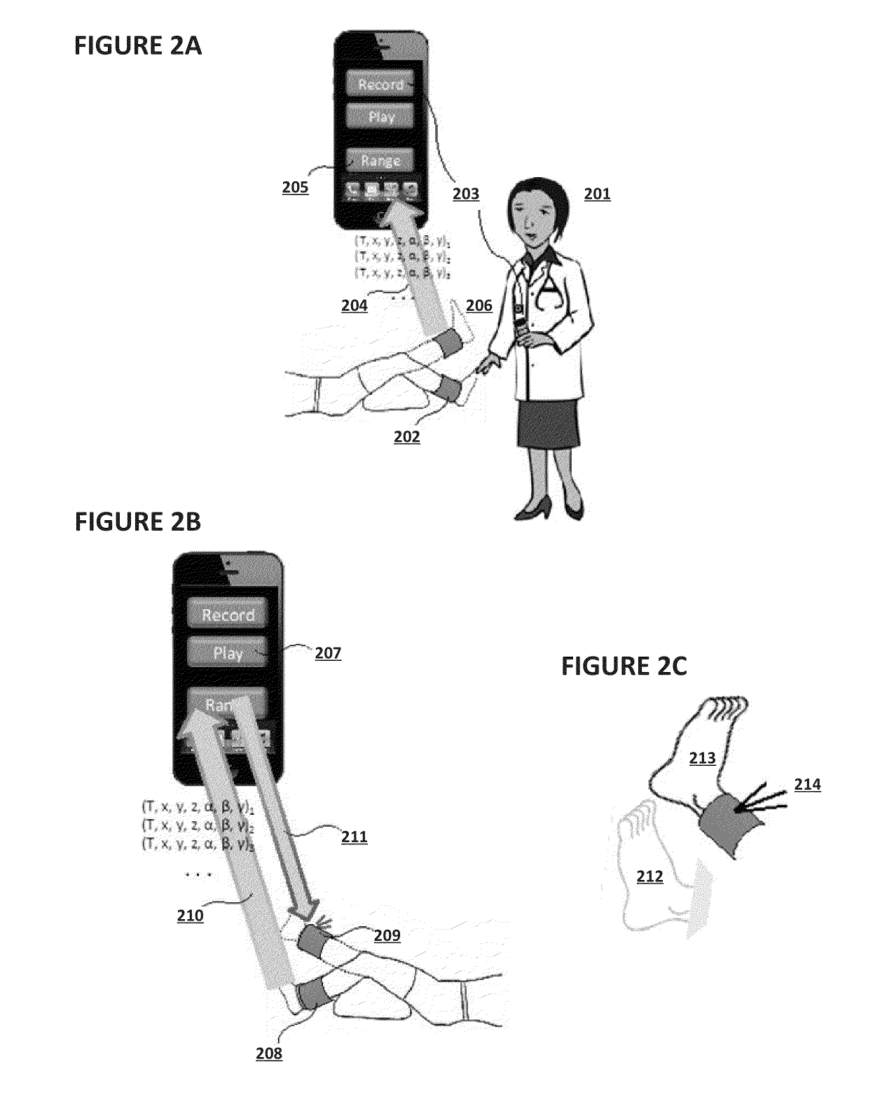

FIGS. 2A-C illustrates an exemplary use case in which a system for recording and communicating human body motion may be implemented. FIG. 2A illustrates that such a use case may be initiated at a medical or physical therapy clinic by recording a set of one or more motions. Under the guidance of a physical therapist (or other medical professional) 201, the user practices an exercise wearing one or more wearable devices 100. The illustration illustrates the movement of a leg wearing a wearable device 100 (e.g., cuff) to move from a first leg position 202 to a second leg position 206.

Before the exercise begins, the physical therapist 201 may open and/or otherwise activate an app on a mobile device (e.g., an iPhone) 203 to record a set of one or more motions. While the physical therapist 201 is guiding the user through the exercise, the sensors 105 of wearable device 100 captures data 204 regarding the time-based positional (x, y, z) and rotational (α, β, γ) motion of the wearable device(s) 100. Such data 204 may then be transferred wirelessly by wireless interface 106 to the mobile device 203, which records the data 204 for the set of motions that make up the exercise. The physical therapist may indicate to the mobile device 203 when the exercise has ended, thereby stopping the recording.

Additional data may be provided (e.g., specified by the physical therapist 201) in association with the set of motions, including a tolerance range 205 (e.g., maximum acceptable deviation) regarding the extent of the motion(s) before tactile guidance is to be triggered during playback. For example, when the user has raised their leg as far as possible (e.g., position 206), that limit may be recorded for comparison later. During playback, the limit is allowed to change within the specified range 205 before any tactile guidance is provided. This supports measureable progress toward functional goals.

FIG. 2B illustrates a subsequent moment when the user is no longer being guided by the physical therapist 201. For example, the user may be at home or another site. The user may wish to begin practicing the set of motions recorded in the presence of the physical therapist 201 in accordance with the description relating to FIG. 2A. As such, the user may select the PLAY button 207. As discussed later herein, some embodiments allow the user access to a variety of different sets of motions, in which case the user may select from a menu. Where the user selects the set of motions recorded in FIG. 2A, data 204 regarding that set of motions may be recalled from memory (of either wearable device 100 or mobile device 203) and compared to real-time motions performed by the user.

As the user moves, the wearable device 100 (now in playback mode) evaluates the movements in real-time (e.g., from position 208 to position 209) to generate time-based positional (x, y, z) and rotational (α, β, γ) data. Such data regarding the real-time movements is compared to the data 204 regarding the recorded set of movements. Such comparison may occur at either the wearable device itself 100 or the mobile device 203. Depending on where the comparison occurs, the wearable device 100 may transmit data characterizing the real-time movements via wireless communication channel 210 to the mobile device 203, or the mobile device 203 may transmit data regarding the stored set of movements via wireless communication channel 211 to the wearable device 100.

The device performing the comparison may detect a deviation that meets or crosses a threshold amount, which may be based on a default or specified tolerance range 205. Such a deviation may occur when the user has moved outside the specified tolerance range 205. When the deviation is detected, the device that detected the deviation may then trigger one or more vibrators to actuate. Where the comparison is performed by the mobile device 203, the actuation signal may be transmitted via wireless transmission channel 211 to the wearable device 100.

FIG. 2C illustrates an exemplary deviation and associated vibration pattern. The stored data 204 may indicate that the wearable device 100 should be in position 212. The deviation may be detected based on identifying that wearable device 100 is in position 213 rather than position 212, and that position 213 meets or surpasses the specified tolerance range 205 from position 212. A type or extent of the deviation may also be determined. For example, the deviation may be positional (e.g., where the user starts the movement in position 213 rather than position 212). The deviation may also be rotational (e.g., where the user adds a twisting motion where none was present in the stored data 204).

Based on the identified deviation, a signal may be generated and sent to actuate the vibrating elements 102 in the wearable device 100. The signal may indicate which vibrating elements 102 to actuate, as well as a strength level and/or pattern 214 by which the vibrating elements 102 vibrate. For example, a simple positional deviation by a small amount may correspond to a low level vibration of a single vibrating element 102 to simulate a gentle push. A larger deviation may trigger a higher level of vibration. Each individual vibrating element 102 may further vibrate in an individual pattern (e.g., multiple vibrations, short vibrations, long vibrations). Where the deviation may be more complex (e.g., twisting in addition to positional), multiple vibrating elements 102 may be actuated in a particular coordinated pattern (e.g., axially, circumferentially, clockwise, counter-clockwise).

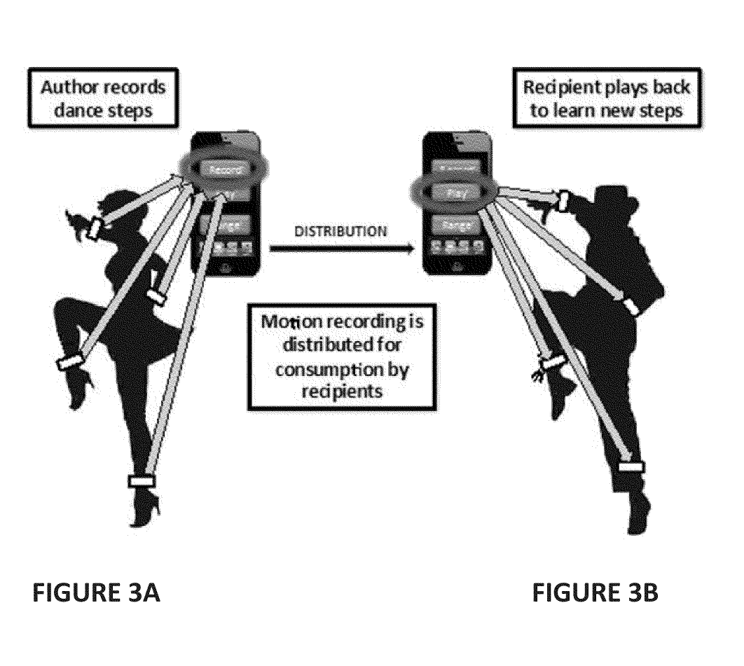

FIGS. 3A-B illustrates another exemplary use case in which a system for recording and communicating human body motion may be implemented. Here, FIG. 3A illustrates a first user recording a dance while wearing wearable devices 100 on their wrists and ankles. The mobile device of that first user may then share the data regarding the dance with the mobile device of another user. Such sharing may occur directly (e.g., from device-to-device) or may occur via an intermediary device or repository.

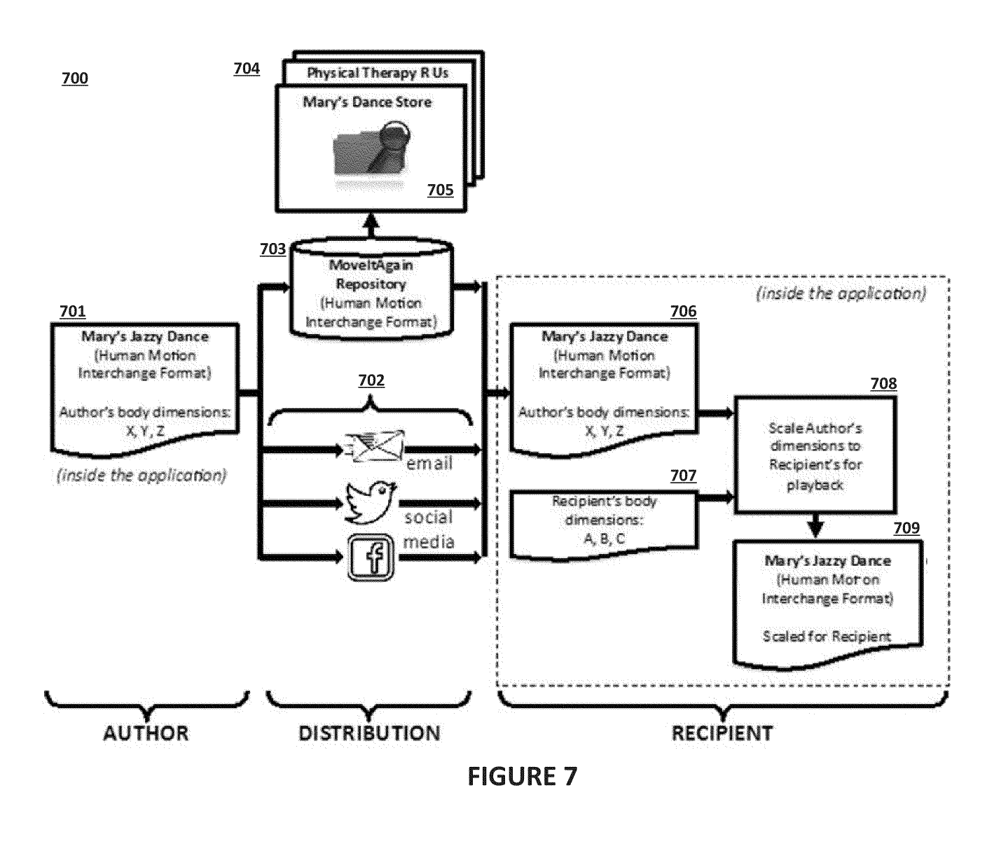

The recording can be transmitted to recipients through various channels. For example, the author can send it directly to recipients via email or it can be posted to social media sites. Alternately, the recording can be uploaded to a repository (discussed in further detail below with respect to FIG. 7) to be provisioned through online storefronts or other portals. Such channels permit consumers to search for different types of recordings. It permits a mix of recordings to be tagged or grouped (e.g., as a physical therapy routine for a specific user's condition). Finally, a centralized online repository also permits creators to promote and sell their motion recordings.

FIG. 3B illustrates the second user wearing corresponding wearable devices and playing back the dance recorded by the user of FIG. 3A. Once a recipient has received the recording, the application may use the body dimensions of the author (recording user) and the recipient (playback user) to scale the recorded movements to the particular dimensions of the recipient during playback. Real-time data regarding movements of the playback user may therefore be compared to the scaled data for the recorded movements for deviations. When a deviation is detected, one or more signals may be sent to one or more of the wearable device(s) worn by the playback user to actuate vibration of one or more of the vibrating elements in a manner corresponding to the detected deviation.

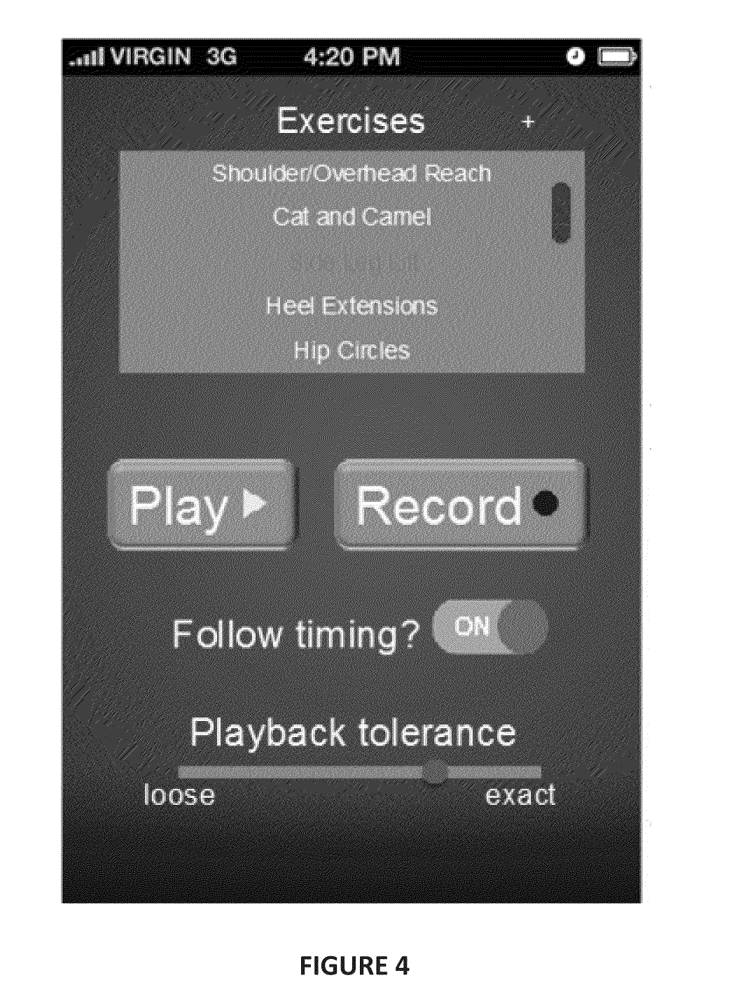

FIG. 4 is a screenshot of an exemplary menu on a mobile device that may be used in a system for recording and communicating human body motion. As can be seen, the mobile device may display a scrollable menu with multiple options for different sets of movements (e.g., shoulder/overhead reach, cat and camel, side leg lift, heel extensions, hip circles). In some embodiments, the menu may be filtered, sorted, and/or allow for searching. Options listed in the menu may also be deleted, added, or edited. Adding an option may involve selecting the “+” sign and entering a name. The name may be greyed out (or otherwise indicated) if not associated with a set of motions.

The display may further include an option to RECORD a new set of motions, as well as playback a selected (from the menu) set of motions that were previously recorded. Various other options (e.g., follow timing, tolerance) may also be provided. Follow timing is an option that considers differences in timing between the stored motions and the real-time motions. Such an option may be enabled where the motions pertain to dancing, so that differences in timing are considered a deviation. The follow timing option may be disabled, however, for physical therapy exercises to allow the user to move at their own pace. Playback tolerance may be set as a percentage-tolerated deviation (e.g., ‘exact’=0% tolerance; ‘loose’=100% tolerance).

Additional options may allow the user to set a starting lag period (e.g., 3 seconds after selection of a set of motions) before evaluation of real-time movements begins, a number of repetitions, or frequency.

Some options may be enabled and disabled based on whether any wearable devices are currently registered and detected as being within a certain distance of the mobile device. Some options may further require selection of a set of motions before being enabled. For example, the PLAY, follow timing, and playback tolerance may not be enabled until a (non-grey) set of motions is selected from the menu, and RECORD may be disabled until an exercise is selected. In the latter case, where an existing (non-grey) exercise is selected, the user may be presented with the option of recording over a pre-existing set of motions.

Exemplary algorithms for recording a set of motions may provide as follows:

```
[user] If (User presses ”+” for a new exercise) then
    • They are prompted for a name that must not match an existing
        exercise.
    • The new exercise is added to top of the list and is gray (no
        recording yet).
    • The new exercise stays selected.
  Endif
  [user] User presses ”Record”
        If (User had selected an existing ’white’ exercise to re-record)
        then
          • A dialog appears with, ”Replace the current recording?”
              with ”OK” and ”Cancel”
          • If ”OK”, then go to ”Record an Exercise” page
        Elsif (User had selected a new ’gray’ exercise to record)
              Go to ”Record an Exercise” page
        Else (User had not yet selected an exercise) then
              Treat the same as ”+”.
        Endif
```

Referring back to FIG. 3A, the recording of the dance performed by the recording user may be give a name (e.g., “Mary's Jazzy Dance”) and be characterized and stored in a human motion interchange format, which may capture such information as:
Title of the motion (or set of motions)
Brief description
Recording user identifier
Creation date
Digital rights
Recording user's body dimensions to permit scaling to a different playback user:
   Height
   Inseam
   Knee-to-ankle
   Sleeve
   Elbow-to-wrist
For each cuff:
   Placement on body (e.g., left wrist, right ankle)
   The (T, x, y, z, α, β, γ)-tuples for the motion where:
      T=time
      x, y, z=Cartesian location for each T
      α, β, γ=Euler angles for each T

Correspondingly, exemplary algorithms for playback of recorded motions may provide as follows:

[user] On the intro screen, the user selects an exercise from the list. If a grayed exercise is selected, then “Play”, “Follow timing?”, and “Playback tolerance” are disabled. Otherwise, they are enabled.

[user] User presses Play and optionally adjusts “Follow timing?” and “Playback tolerance”.

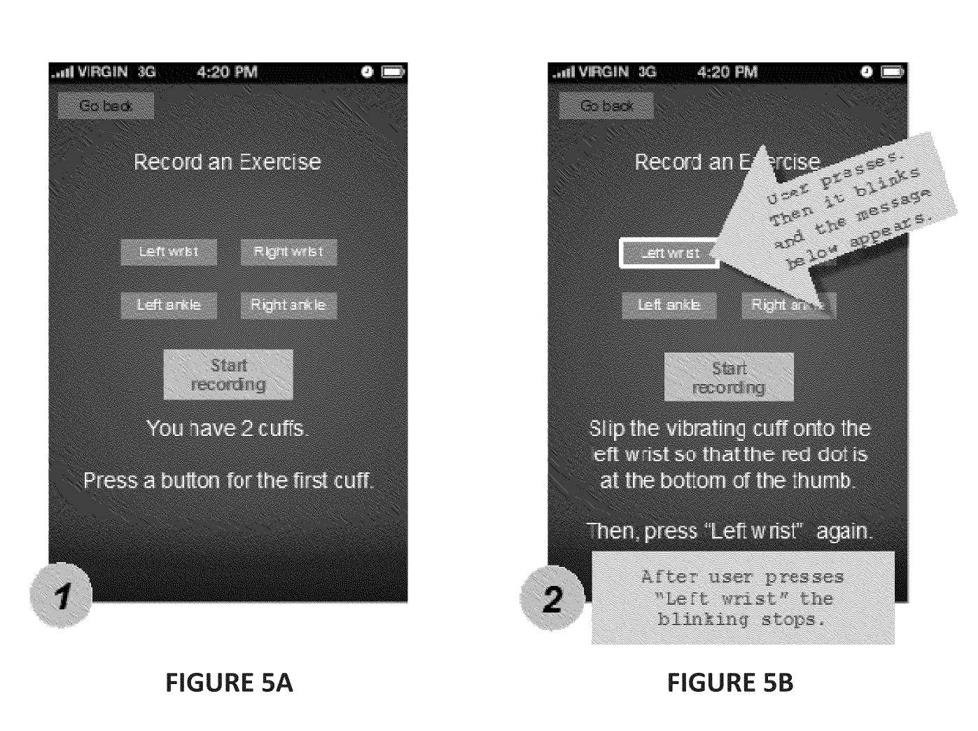

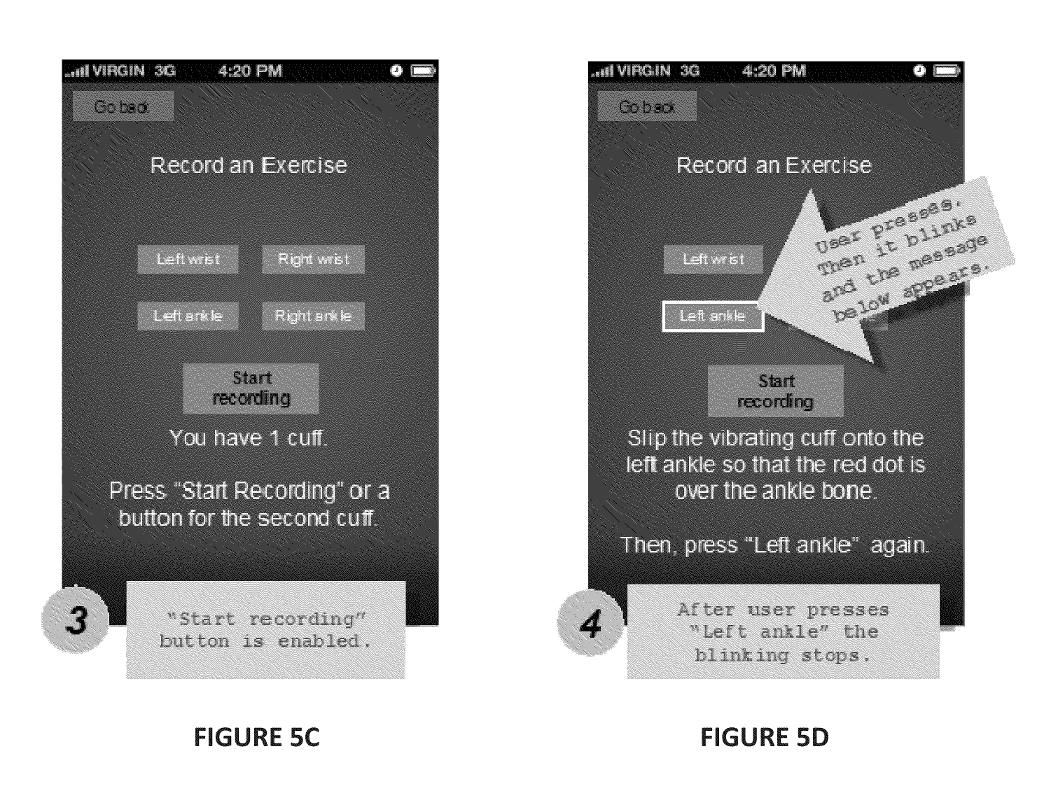

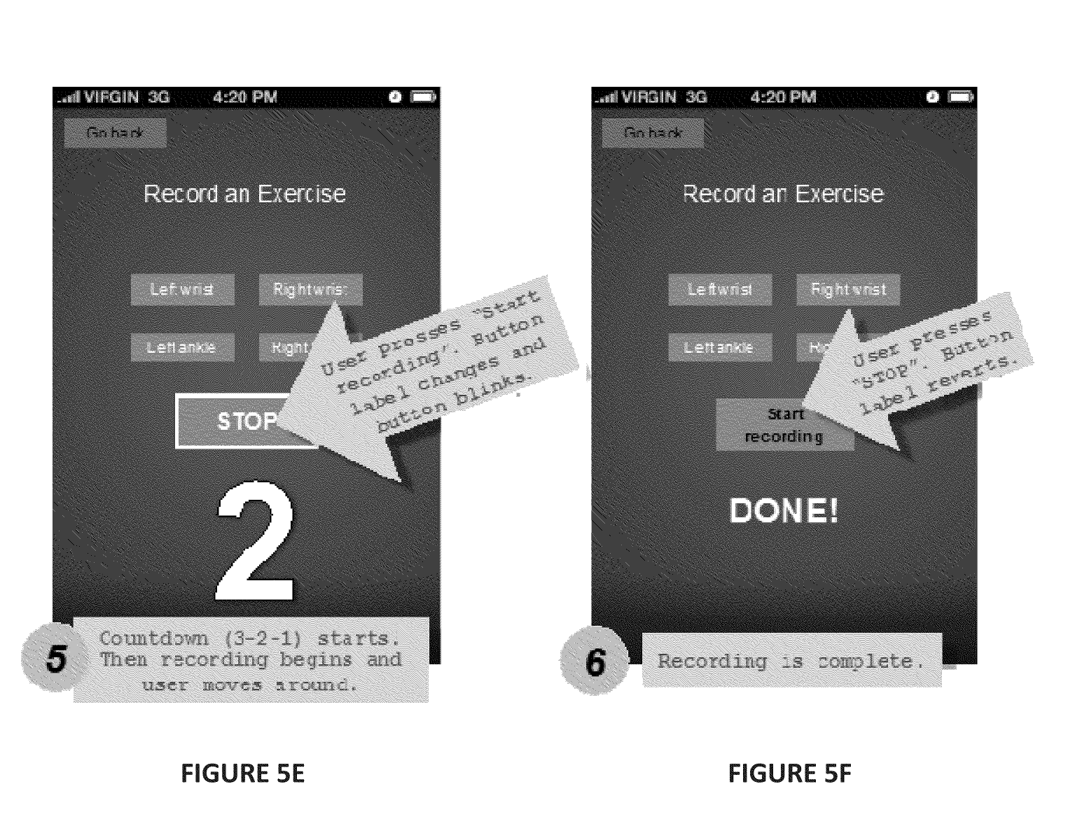

FIGS. 5A-F are screenshots that appear on the mobile device of FIG. 4 during an exemplary recording of a body motion. Once the RECORD option is selected from the display screen in FIG. 4, the mobile device may provide various options related to registering and synchronizing the wearable device(s).

FIG. 5A indicates that the mobile device has detected two wearable devices (e.g., cuffs) and provides options for how the user may wear such wearable devices (e.g., wrists, ankles). In response to the instruction “Press a button for the first cuff” in FIG. 5A, the user may select one of the options (e.g., left wrist, right wrist, left ankle, right ankle).

Once the user has selected a body part for the wearable device, one of the detected wearable devices may be sent a signal to vibrate. FIG. 5B is a screenshot in which directions appear instructing the user which wearable device to put on which body part. Such instructions may further provide how to position to wearable device on the selected body part (e.g., “slip on the vibrating cuff onto the left wrist so that the red dot is at the bottom of the thumb”). While the exemplary instructions refer to a “red dot” as a positioning tool, any other type of indicator known in the art—whether visual, mechanical, or otherwise—may be used as a point of reference for positioning the wearable device on the user body part. Additional instructions may tell the user to press the selected body part again (e.g., to confirm that the wearable device has been put on the indicated body part).

FIG. 5C illustrates that when at least one wearable device is worn, the option to “START RECORDING” may be enabled. The user may, however, choose to register additional wearable devices on other body parts. If so, the user may be provided with additional directions for placing and positioning the next wearable device, as illustrated in the screenshot of FIG. 5D.

When the user is ready to start recording, the user may select the “START RECORDING” button. FIG. 5E is a screenshot of a display that may appear following such a selection. The “START RECORDING” button becomes a “STOP” button to be pressed when the recording user wishes to stop recording. In some instances, a countdown (e.g., 3 seconds) allow the user to put down their mobile device and get into a desired starting position before the recording begins. When the user has completed the set of motions desired for the recording, the user may select the “STOP” button at which point the button may revert to “START RECORDING” as illustrated in FIG. 5F.

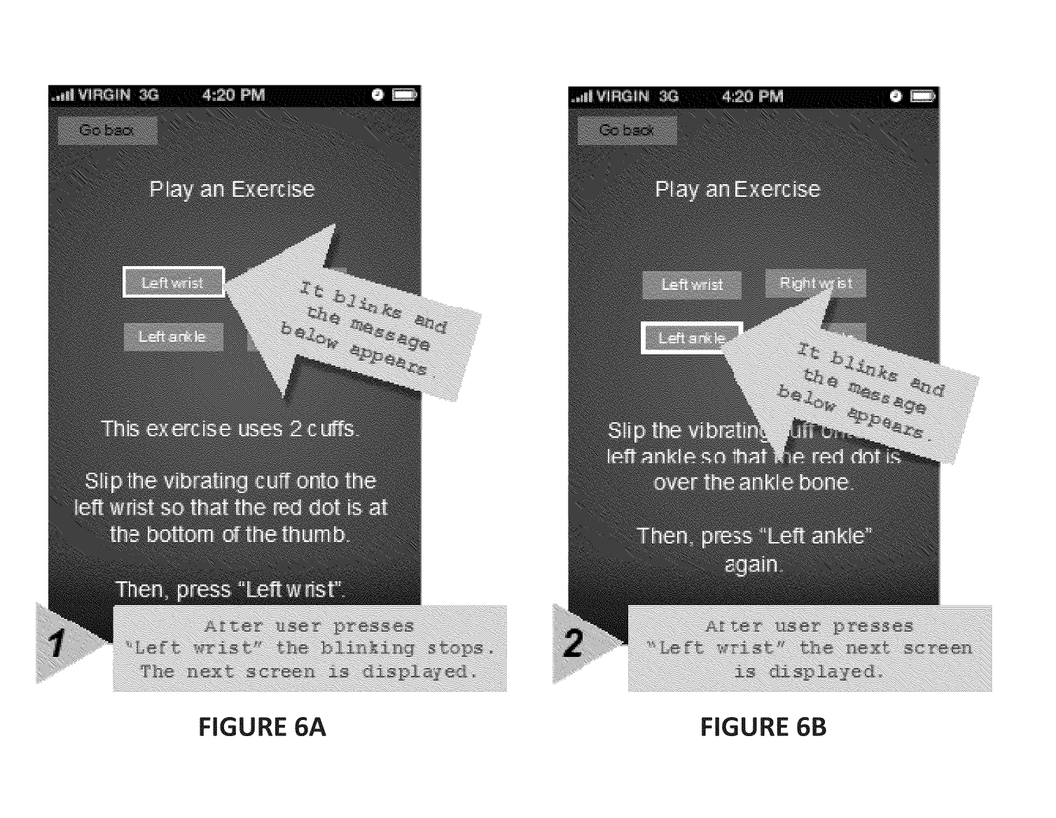

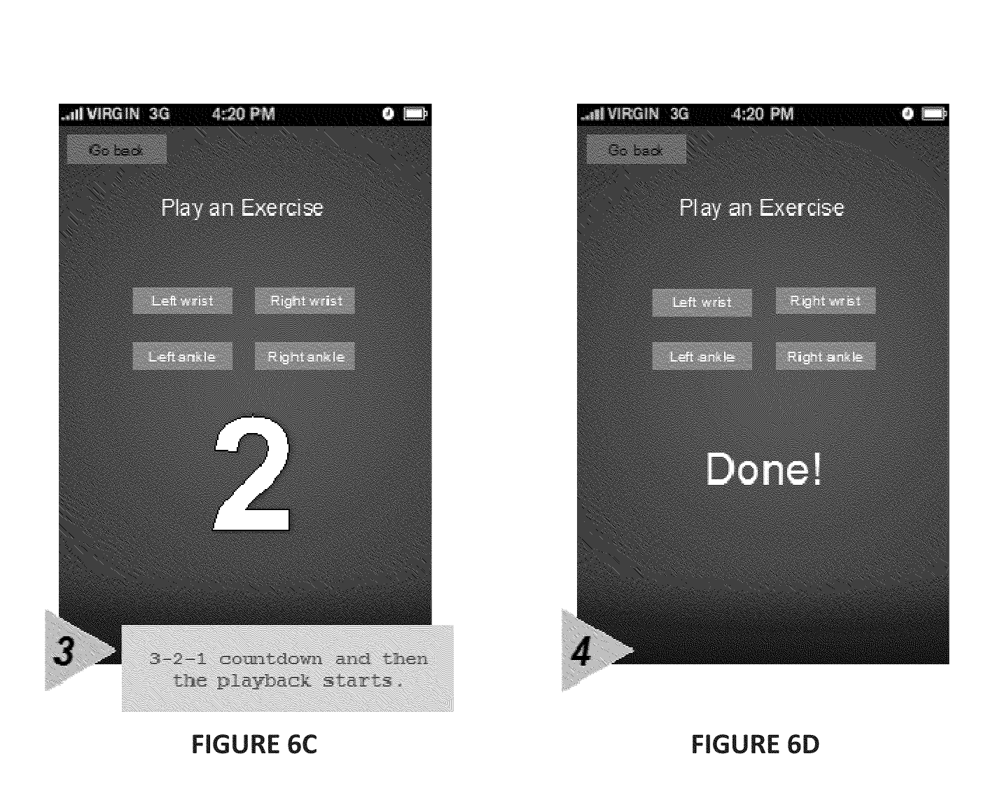

FIGS. 6A-D are screenshots that appear on the mobile device of FIG. 4 during an exemplary playback of a body motion. Similar to the instructions provided with respect to the recording of motions described for FIGS. 5A-D, the playback user is instructed how to register, place, and position their wearable device(s) in FIGS. 6A-B.

FIG. 6C is a screenshot of the mobile device as playback is about to begin. Such a screenshot includes a countdown which allows the playback user to put down the mobile device and ready themselves to begin the set of motions. FIG. 6D is a screenshot that indicates that the set of motions has completed playback.

In some embodiments, the application may allow for verbal or spoken commands to control the recording or playback of motions. Instead, the playback user may issue verbal keyword commands recognized by the mobile device or a wearable device (e.g., via Invensense 40310 ‘Always On’ microphone and associated keyword recognition). Such a feature may benefit people uncomfortable with technology and also those with very limited range of motion. Keywords may include “Move It Again” to wake up the device, “List”, “Play”, “Stop”. In addition, the mobile device or wearable device may provide audio instructions associated with the recorded set of motions. Such audio instructions may have been recorded by the recording user (e.g., “Keep your shoulders relaxed”) or generated dynamically based on the deviation (e.g., “Bend your right leg” corresponding to the vibrating elements simulating a push on the right ankle to guide the bending of the right leg).

FIG. 7 is a diagram of an exemplary network environment 700 in which a system for recording and communicating human body motion may be implemented. Such a network environment may include one or more authors (recording users), distributors, and recipients (playback users). At an exemplary application 701 associated with the recording user (e.g., the recording user of FIG. 3A), the recording user may record a set of motions (e.g., “Mary's Jazzy Dance”). Data regarding such motions may be stored in a human motion interchange format, which may indicate the particular dimensions of the recording user.

A communication network that allows for communication between authors, distributors, and recipients may be a local, proprietary network (e.g., an intranet) and/or may be a part of a larger wide-area network. Such a communication network may comprise a variety of connected computers that may provide a set of network-based services. Such network service may be provided by real server hardware and/or by virtual hardware as simulated by software running on one or more real machines. Such virtual servers may not physically exist and can therefore be moved around and scaled up (or down) on the fly without affecting end-users (e.g., like a cloud). Various available paths or channels may include any type of data communication link known in the art, including TCP/IP connections and Internet connections via Wi-Fi, Bluetooth, UMTS, etc. In that regard, communications network may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider.

The application 710 of the recording user may be used to share and distribute the recorded motions with a variety of outlets, including email and social media channels 702 and online repositories 703. Such online repositories may be grouped based on any characteristic, including author affiliation or specific portals 704 (e.g., dances provided by the “Mary's Dance Store” portal 705 or exercises provided by “Physical Therapy R Us”). Additionally, each set of motions may be tagged to indicate one or more type of motions (e.g., sports, dance, physical therapy), level of exertion, level of difficulty, condition-specific motions, and any other tag desired by the recording user or playback user(s) that have practiced the set of motions. Such tags allow for ease and convenience of discovery and searching by other users. For example, a user may wish to find an exercise to strengthen their legs, but that is low-impact on the knees.

A particular recipient (playback user) may discover and download (with or without payment) a set of motions from one of the distribution channels described above onto their mobile device (hosting a corresponding application for managing recorded movements). For example, the playback user may opt to download a recording 706 of a set of motions (e.g., “Mary's Jazzy Dance”). The application may register the playback user's wearable devices and determine dimensions 707 of the playback user. Upon determining that such dimensions 707 of the playback user are different from the dimensions of the recording user of “Mary's Jazzy Dance,” one or more scaling factors may be identified (e.g., different height, arm length, leg length, distance between arm and leg) to customize the set of motions to the playback user. As such, the real-time motions of the playback user may be compared to a rescaled set of data corresponding to the selected set of motions.

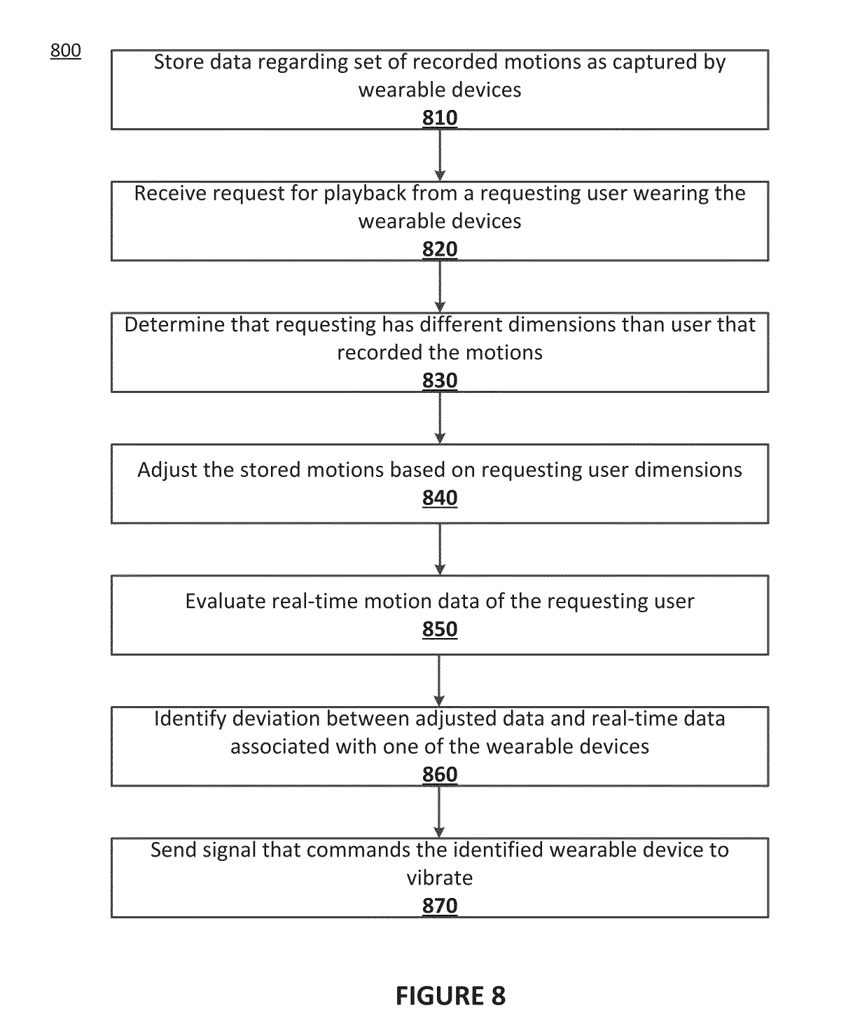

FIG. 8 is a flowchart illustrating an exemplary method 800 for recording and communicating human body motion. The method illustrated in FIG. 8 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 8 (and the order thereof) are exemplary and may include various alternatives, equivalents, or derivations thereof including but not limited to the order of execution of the same.

In method 800, data regarding a set of motions may be captured by one or more wearable devices and stored in memory. A request may be received regarding playback of the set of motions. It may be determined that the requesting user has different dimensions that the recording user. The stored data regarding the set of motions may be adjusted and scaled based on the identified difference(s) in dimensions. Data regarding real-time motions performed by the playback user may be evaluated and compared to the adjusted/scaled data. When a deviation is detected and determined to meet a threshold tolerance range, such deviation may be evaluated and used to generate a signal to one or more wearable devices regarding actuation of one or more vibrating elements therein in a particular manner so as to provide tactile guidance that corrects the playback user.

In step 810, a recording user may perform a set of motions, and data regarding the performed set of motions is captured by wearable devices worn by the recording user. The data may be stored in memory of the wearable device, sent to an associated mobile device, or to an online repository where it may be made available to other users.

In step 820, a request is received from a user regarding playback of the set of motions. The requesting user may or may not be the same user that recorded the motions. The set of motions may be selected from a local menu (if stored on the wearable device or local associated mobile device) or from a menu generated based on downloaded information (if stored in an online repository).

In step 830, the requesting user is instructed to don one or more wearable devices, which determine the dimension of the requesting user. The dimensions may be compared to data associated with the set of motions to identify whether the dimensions are the same (e.g., the user requesting playback may be the same user that recorded the motions) or different.

In step 840, a difference in dimensions may be used to adjust the stored data regarding the set of motions. The stored data represents the positions over time to which the playback user is expected to conform. Because of the differences in dimensions that may exist compared to the recording user, however, the playback user may be unable to approximate the same positions, even allowing for generous tolerance ranges. As such, the stored data may be adjusted based on one or more identified differences in dimensions between the recording user and the playback user. For example, if the playback user is shorter than the recording user, the expected positions for the wearable devices worn by the playback user may be accordingly decreased based on the difference in height.

In step 850, data regarding real-time movement of the playback user may be captured by wearable devices and evaluated. Specifically, such data may be compared to the motion data that was adjusted in step 840. Exemplary algorithms for comparing data regarding actual, real-time position/movement to expected position/movement (as indicated by stored, adjusted data) may provide as follows:

During Record mode, the application stores the Expected stream of time-based 6-degree of freedom data.
E(T, x, y, z, α, β, γ)₁
E(T, x, y, z, α, β, γ)₂
E(T, x, y, z, α, β, γ)₃

Such data may be adjusted based on dimensions. At Playback, the Actual stream of data from the cuff(s) is compared to the stored (and adjusted) reference:
A(T, x, y, z, γ, β, γ)₁
A(T, x, y, z, γ, β, γ)₂
A(T, x, y, z, γ, β, γ)₃

Various tolerance ranges may be defined, including positional (ΔP) and rotational (ΔR). Such tolerance may be provided as a percentage. For example, if the tolerance is 10% and x=50 cm, then any value of x from 45 to 55 would be considered within range.

In step 860, a deviation may be identified between the adjusted data and the real-time data. Such deviation may be identified in terms of which wearable device(s), type of deviation, amount of deviation, type of correction, etc., and any other factor related to characterizing or correcting the deviation.

In step 870, a signal is sent to one or more wearable devices regarding actuation of one or more vibrating elements in a particular manner (e.g., pattern) corresponding to the deviation. As noted above, a vibration pattern may be individual to a single vibrating element or may be coordinated across multiple vibrating elements and wearable devices.

Variations upon method 800 may provide for features allowing for management of session timing, handling movement within tolerance ranges, and other playback features. Managing logic timing may involve defining how to track playback progress through the recorded exercise given that the user may have to stop, get back on track, and start again. Because the playback user may make mistakes, they may not be able to precisely follow the recorded (expected) timing and may need additional time to get back on track. Therefore, it may be necessary to manage the elapsed session time (which may stop and start), distinct from the system time (which is the system clock). Such elapsed time stored with a recording may start at zero and correspond to the session time during playback. If the user makes a mistake, then session timing may be stopped until the user gets back into correct position. Then the session timing may resume, once again allowing for comparison to the recorded timing. As such, data transformations may not be required with respect to timing. Exemplary algorithms for managing session timing may provide as follows:

```
Note: If ”follow_timing” is FALSE, the ”Main Logic Loop for Playback”
does not call these timing functions. Exercises are followed in sequence
but not synched to the recorded session time.
long session_time = 0
long last_system_time = 0
BOOLEAN session_timer_is_stopped = TRUE
void start_session_timer( ){
      last_system_time = system_time( ) // ”system_time( )” is per
      system clock
      session_timer_is_stopped = FALSE
}
void stop_session_timer( ){
      session_time = session_time + ( system_time( ) −
      last_system_time )
      last_system_time = system_time( )
      session_timer_is_stopped = TRUE
}
long get_session_time( ) {
      // this utility function is for reporting; not needed in algorithms
      time_to_return = 0
      if(session_timer_is_stopped) then
            time_to_return = session_time
      else
            time_to_return = system_time( ) − last_system_time
      fi
      return(time_to_return)
}
```

Handling movement within tolerance ranges may involve evaluating various criteria to determine whether user needs feedback as they move through the x/y plane and the z-axis. Exemplary algorithms for handling movement within such tolerance ranges may provide as follows:

```
BOOLEAN user_is_close_enough( E(T, x, y, z, α, β, γ)N) {
      if( follow_timing ) then
            // E(T)N is session time T
            // else, compare to other E variables in sequence, not
            synched by time
      fi
            // A = Actual (in current session); E = Expected (from
            recording)
      xx = yy = 0 // ’left/right’ and ’up/down’
      If ( E(x) > A(x) + ΔP ) xx =1
      If ( E(x) < A(x) − ΔP ) xx =−1
      If ( E(y) > A(y) + ΔP ) yy =1
      If ( E(y) < A(y) − ΔP ) yy =−1
      case (yy)
            0:
                  if(xx = 0) // do nothing
                  if(xx = 1) buzz(3:00)
                  if(xx = −1) buzz(9:00)
            1:
                  if(xx = 0) buzz(12:00)
                  if(xx = 1) buzz(1:30)
                  if(xx = −1) buzz(10:30)
            −1:
                  if(xx = 0) buzz(6:00)
                  if(xx = 1) buzz(4:30)
                  if(xx = −1) buzz(7:30)
      end
      // In the z axial direction, the corrective buzzes are either:
            // ’backward’- Pulse the front, then middle, then back cuff
            vibrator ring.
            // ’forward’- Pulse the back, then middle, then front cuff
            vibrator ring.
      zz = 0
      if ( E(z) > A(z) + ΔP ) zz = 1
      If ( E(z) < A(z) − ΔP ) zz = −1
      case (zz)
            0: continue
            1: buzz(backward)
            −1: buzz(forward)
      return( xx || yy || zz )
}
```

Additional algorithms may be provided for retrieving and processing the recorded session for playback as follows:

During Record mode, the application stores the Expected stream of time-based 6-degree of freedom data (time, T, starts at zero):
E(T, x, y, z, α, β, γ)₁
E(T, x, y, z, α, β, γ)₂
E(T, x, y, z, α, β, γ)₃

The main loop for playback, below, is initialized by popping the first data point. Then the ‘while’ loop is executed as the user interacts. If the user gets off track, then the session timer is stopped until the user is back on track per repeated execution of user_is_close_enough( ).

```
max_allowable_delay = 30 // The limit (in seconds) for a user to be off
track
get first playback data point // E(T, x, y, z, α, β, γ)1
while(playback data remains)
do
      if( user_is_close_enough( ) ) then
            if( follow_timing && session_timer_is_stopped ) then
                  // The user was off track, but now they are on track
                  so start the
                  // session timer and pop the next data point.
                  start_session_timer( )
            fi
            get next data point // E(T, x, y, z, α, β, γ)N
      else
            if( follow_timing )
                  if( ! session_timer_is_stopped ) then
                        // Stop session timer while the user corrects
                  their position
                        stop_session_timer( )
                  fi
                  if(system_time( ) − last_system_time >
                  max_allowable_delay)
                        // The user has taken too long to get on track
                        display(”Let's try this exercise again. Press
                        ’Playback’ when you are ready.”)
                        Stop
                  fi
            fi
      fi
done
```

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for recording and communicating human body motion, the method comprising:
storing data in memory, the stored data captured by one or more wearable devices and characterizing a set of motions performed over a period of recording time by a recording user wearing the wearable devices, wherein each motion in the set of motions is associated with a time within the period of recording time that the motion was performed;
receiving a request at a user interface, the request for playback of the set of motions from a playing user wearing the wearable devices, wherein the wearable devices send data regarding dimensions of the playing user;
determining that the playing user has different dimensions than the recording user;
adjusting the stored data regarding the set of motions performed by the recording user, wherein the adjustment is based on the difference in dimensions between the recording user and the playing user;
evaluating real-time data regarding a set of motions performed by the requesting user over a period of playing time corresponding to the period of recording time;
identifying a deviation between the adjusted data and the real-time data, wherein the identified deviation is associated with at least one of the wearable devices; and
sending a signal over the wireless communication network to the wearable device associated with the identified deviation, wherein the signal commands one or more vibrating elements of the identified wearable device to actuate.

2. The method of claim 1, further comprising sending the stored data characterizing the recorded set of motions over the wireless communication network to a repository that stores a plurality of different sets of recorded motions.

3. The method of claim 2, further comprising sending a request over the wireless communication network to the repository, the request concerning for another set of recorded motions that meets one or more parameters.

4. The method of claim 3, wherein the repository catalogues each of the plurality of different sets of recorded motions by references to the parameters.

5. The method of claim 4, wherein the repository conducts a search of the catalogue based on the requested parameters to identify the other set of recorded motions, and further comprising receiving the identified other set of recorded motions sent from the repository over the wireless communication network.

6. The method of claim 5, wherein the other set of recorded motions is created based on one or more of the different sets of recorded motions that meets the requested parameters.

7. The method of claim 1, further comprising sharing the stored data characterizing the recorded set of motions with one or more social media services, wherein a link to the stored data is shared over the wireless communication network with a network associated with the social media services.

8. The method of claim 1, further comprising registering the wearable devices, each wearable device comprising:
a set of sensors for characterizing motion,
a set of vibrating elements, wherein the vibrating elements are placed at different locations on the wearable device, and
a radio for communicating over a wireless communication network.

9. The method of claim 1, wherein the identified deviation is characterized by a deviation amount and a deviation type, and wherein a vibration force and pattern is based on the deviation amount and deviation type.

10. The method of claim 1, further comprising playing an audio command based on the deviation.

11. A system for recording and communicating human body motion, the system comprising:
memory that stores data captured by one or more wearable devices, the stored data characterizing a set of motions performed over a period of recording time by a recording user wearing the wearable devices, wherein each motion in the set of motions is associated with a time within the period of recording time that the motion was performed;
a user interface that receives a request for playback of the set of motions from a playing user wearing the wearable devices, wherein the wearable devices sends data regarding dimensions of the playing user;
a processor that executes instructions stored in memory, wherein execution of the instructions by the processor:
determines that the playing user has different dimensions than the recording user,
adjusts the stored data regarding the set of motions performed by the recording user, wherein the adjustment is based on the difference in dimensions between the recording user and the playing user,
evaluates real-time data regarding a set of motions performed by the requesting user over a period of playing time corresponding to the period of recording time, and
identifies a deviation between the adjusted data and the real-time data, wherein the identified deviation is associated with at least one of the wearable devices; and
a communication interface that sends a signal over the wireless communication network to the wearable device associated with the identified deviation, wherein the signal commands one or more vibrating elements of the identified wearable device to actuate.

12. The system of claim 11, further comprising a repository that stores a plurality of different sets of recorded motions, wherein the communication interface sends the stored data characterizing the recorded set of motions over the wireless communication network to the repository.

13. The system of claim 12, wherein the communication interface sends a request over the wireless communication network to the repository, the request concerning for another set of recorded motions that meets one or more parameters.

14. The system of claim 13, wherein the repository catalogues each of the plurality of different sets of recorded motions by references to the parameters.

15. The system of claim 14, wherein the repository conducts a search of the catalogue based on the requested parameters to identify the other set of recorded motions and sends the identified other set of recorded motions over the wireless communication network to the communication interface.

16. The system of claim 15, wherein the repository identifies one or more of the different sets of recorded motions that meets the requested parameters, and wherein the other set of recorded motions is created based on one or more of the different sets of recorded motions identified as meeting the requested parameters.

17. The system of claim 11, wherein the repository shares the stored data characterizing the recorded set of motions with one or more social media services, wherein a link to the stored data is shared over the wireless communication network with a network associated with the social media services.

18. The system of claim 11, wherein the wearable devices are registered, each wearable device comprising:
a set of sensors for characterizing motion,
a set of vibrating elements, wherein the vibrating elements are placed at different locations on the wearable device, and
a radio for communicating over a wireless communication network;

19. The system of claim 11, wherein the identified deviation is characterized by a deviation amount and a deviation type, and wherein a vibration force and pattern is based on the deviation amount and deviation type.

20. The system of claim 11, further comprising playing an audio command based on the deviation.

21. A non-transitory computer-readable storage medium, having embodied thereon a program executable by a processor to perform a method for recording and communicating human body motion, the method comprising:
storing data in memory of a mobile device, the stored data captured by one or more wearable devices and characterizing a set of motions performed over a period of recording time by a recording user wearing the wearable devices, wherein each motion in the set of motions is associated with a time within the period of recording time that the motion was performed;
receiving a request at a user interface of the mobile device, the request for playback of the set of motions from a playing user wearing the wearable devices, wherein the wearable devices send data regarding dimensions of the playing user;
determining that the playing user has different dimensions than the recording user;
adjusting the stored data regarding the set of motions performed by the recording user, wherein the adjustment is based on the difference in dimensions between the recording user and the playing user;
evaluating real-time data regarding a set of motions performed by the requesting user over a period of playing time corresponding to the period of recording time;
identifying a deviation between the adjusted data and the real-time data, wherein the identified deviation is associated with at least one of the wearable devices; and
sending a signal over the wireless communication network to the wearable device associated with the identified deviation, wherein the signal commands one or more vibrating elements of the identified wearable device to actuate.
